(19) United States
(12) Patent Application Publication
(10) Pub. No.: US 2004/0228971 A1
(43) Pub. Date: Nov. 18, 2004

(54) Modified polyacetals for decorative applications

(76) Inventor: Pascal Scaramuzzino, Luasanne (CH)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/816,421

(22) Filed: Apr. 1, 2004

Related U.S. Application Data
(60) Provisional application No. 60/470,084, filed on May 13, 2003.

(51) Int. Cl. B05D 3/00; B05D 3/10

(52) U.S. Cl. 427/299; 427/307

(57) ABSTRACT

A painted polyacetal article comprises a polyacetal substrate comprising 90-99.5 wt % polyacetal and 0.5-10 wt % of semicrystalline or amorphous thermoplastic non-polyacetal resin of molecular weight 1,000-50,000; and a paint applied to the polyacetal substrate from a solvent-borne, water-borne or powder 1K paint system onto a surface of the polyacetal substrate pretreated to enhance exposure of said semicrystalline or amorphous thermoplastic non-polyacetal resin of the substrate to the applied paint. The paint is a thermoplastic or partly thermoplastic non-thermosetting paint. A layer of thermosetting paint or varnish can be applied over the thermoplastic paint. The painted polyacetal article has improved paint adhesion and good retained physico-mechanical properties.

This application claims the benefit of U.S. Provisional Application No. 60/470,084 filed May 13, 2003 which is incorporated by reference herein for all purposes as if fully set forth.

### FIELD OF THE INVENTION

This invention relates to the bulk modification of polyacetal articles followed by a chemical etching and/or mechanical or physical treatment prior to the application of a paint system, the nature of which could be solvent based, waterborne and/or in powder form. The invention concerns a painted polyacetal article with improved paint adherence and good retained physico-mechanical properties, and a process for producing it.

### BACKGROUND OF THE INVENTION

Polyacetals (sometimes referred to as acetal resins) are a class of polyoxymethylene compositions described for example in U.S. Pat. Nos. 5,318,813, 5,344,882 and 5,286,807. Polyacetal resins are commercialized inter alia by E.I. du Pont de Nemours and Company, Wilmington, Del., USA under the Trade Mark DELRIN®.

Polyoxymethylene compositions (polyacetals) are generally understood to include compositions based on homopolymers of formaldehyde or of cyclic oligomers of formaldehyde, for example trioxane, the terminal groups of which are end-capped by esterification or etherification, as well as copolymers of formaldehyde or of cyclic oligomers of formaldehyde, with oxyalkylene groups with at least two adjacent carbon atoms in the main chain, the terminal groups of which copolymers can be hydroxyl terminated or can be end-capped by esterification or etherification.

Compositions based on polyoxymethylene of relatively high molecular weight, i.e. 10,000 to 100,000 are useful in preparing semi-finished and finished articles by any of the techniques commonly used with thermoplastic materials, e.g. compression molding, injection molding, extrusion, blow molding, rotational molding, melt spinning, stamping and thermoforming. Finished products made from such compositions possess extremely desirable physical properties, including high stiffness, strength, chemical stability and solvent resistance.

It is known that molded articles made of polyacetals, which are highly chemically stable and crystalline, are more difficult to decorate or overmold than other molded plastics materials, and are more particularly more difficult to metallize (by vacuum deposition) or plate (electroless plating or galvanoplating) or paint.

Plastics, in particular polyacetals, which are highly crystalline or have low surface polarity, are normally subjected to physical or chemical surface treatments before paints are applied thereon because of the paints' low adhesiveness. Such treatment methods include the physical method of mechanically roughening the surface, the chemical method of solvent treating, flame treatment, ultraviolet ray treatment, corona discharge treatment, and plasma treatment. All of these methods are intended to improve the adhesiveness of the paints by denaturing the plastic surfaces.

Generally speaking, plastics are quite stable chemically and molded products thereof made by injection molding or the like have a smooth surface, so that it is difficult to decorate the surface thereof by means of printing, coating, deposition or the like, and it is also difficult to subject the surface to processing such as adhesion by means of adhesives. Because polyacetal resin is particularly low in surface activity and there is known no appropriate solvent having an affinity for polyacetal, surface decoration of polyacetal and adhesion thereto are difficult to carry out in practice such that polyacetal resins are rarely put to uses requiring such treatments.

However, the application of plastics has diversified recently and higher value usages are frequently required to simultaneously satisfy multiple criteria, such as function and appearance or function and adhesion properties. Thus, good surface processability is becoming more important for polyacetal.

The surface processability of polyacetals can be improved to some extent by treatment with an acidic solution or an oxidant solution. Acidic solutions of p-toluenesulfonic acid, camphorsulfonic acid, phosphoric acid, acid ammonium sulfate and the like have been proposed, while an oxidant solution of a chromic acid-sulfuric acid mixture has been proposed. An improved process for electroplating is also provided by immersion techniques of the shaped article into quinoline, pyridine or g-butyrolactone prior to the above-mentioned surface treatment with an acid agent solution.

The object of these treatments is to produce a rough surface and simultaneously form reactive groups on a part of the polyacetal molecule by the oxidizing action of the solutions. However, if it is attempted to enhance the effect of a surface treatment by means of such a procedure, problems arise such as deterioration of the polyacetal resin throughout the whole body, leading to loss of strength, the formation of cracks, or a poor surface finish. On the other hand, if the treatment is carried out utilizing a condition which causes no deterioration of the polyacetal, the effect of the surface treatment tends to be insufficient and a good surface processing cannot be practiced.

When treating polyacetal articles in order to improve their surface processability, substantial problems are encountered in controlling the activation of the surface via a chemical modification, and in selecting the polyacetal composition in such a way as to retain its initial bulk properties. The difficulty of treating the surface of a polyacetal resin is moreover evidenced by several observations like a high reject rate when complex shaped parts are immersed in an acidic solution, a poor adhesion of the paint system and/or, above all, a poor retention of the coating's performance in long term testing.

The difficulty of metallizing polyacetal articles is for example described in GB-A 2 091 274, which proposed a preliminary surface treatment by acid etching, for instance using a mixture of 30-60 weight % sulfuric acid, 5-30 weight % hydrochloric acid and 65-10 weight % water; or 20-50 weight % sulfuric acid, 30-50 weight % phosphoric acid and 50-0 weight % water. Mixtures of organic and inorganic acids were also envisaged. After the acid etching, the articles were dipped in a neutralizing solution, undercoated with a urethane paint, metallized by cathodic sputtering and painted with a top coat of an acrylic urethane paint or an acrylic ester paint system.

French Patent Specification FR-A-2,703,074 describes the preliminary surface treatment of polyacetal articles to prepare them for plating, by etching with a mixed acid bath of sulfuric, phosphoric and hydrochloric acids in the amounts 30 vol % sulfuric acid (96/98% purity), 20 vol % phosphoric acid (85% purity), 5 vol % hydrochloric acid (35/37% purity) and 45 vol % water. This process has been moderately successful on a small scale for the plating of articles made of polyacetal copolymers, but its implementation on an industrial scale was not satisfactory due to the noted constraints. Furthermore, the use of this process for the direct application of decorative paints to polyacetal articles has been problematic.

Despite the difficulties encountered to date, it is extremely desirable to surface treat polyacetal articles in particular for applications where the surface appearance is important, while retaining good physico-mechanical properties of the polyacetal and long-term paint adhesion. As above described, there are at present many problems to be overcome in the painting of melt processed polyacetal resin products. Existing methods have proven to be inadequate for painting a wide range of polyacetal articles, in particular complex shapes.

### SUMMARY OF THE INVENTION

The invention provides painted polyacetal article comprising: a polyacetal substrate comprising 90-99.5 wt % polyacetal and 0.5-10 wt % of semicrystalline or amorphous thermoplastic non-polyacetal resin of molecular weight 1,000 to 50,000, usually 5,000-50,000; and a paint applied to the polyacetal substrate from a solvent-borne, water-borne or powder 1K paint system onto a surface of the polyacetal substrate pretreated to enhance exposure of said semicrystalline or amorphous thermoplastic non-polyacetal resin of the substrate to the applied paint. The applied paint is a thermoplastic or partly thermoplastic paint.

The surface treated polyacetal articles according to the present invention are characterized by a low reject rate herein defined as the percentage of shaped parts that break when the shaped parts are surface treated, in particular when they are immersed into an acidic solution, or on which surface artifacts like the formation of cracks are observed. This low reject rate is particularly significant for “massive” complex shaped parts like ski bindings.

The painted polyacetal articles according to the invention are characterized by improved paintability (paint adhesion) and good retained physico-mechanical properties, namely stiffness and toughness, compared to modified polyacetal resins containing inorganic filler soluble in acid solution and/or to polyacetal parts whose surface has been partially or extensively activated by an intensive surface treatment. According to the present invention, the painted polyacetal articles are also characterized by an improved long term adhesion performance after severe aging (80° C., 100% RH, 100-150 hours), the latter being measured according to ISO 2409. The painted polyacetal articles maintain physical impact performance measured, for instance, after 150 hours accelerated weathering under the following conditions: 0.5 W/m², black panel Temperature=65° C.

The advantages of the painted polyacetal article and the method according to the invention are manifold:

i) an improved surface wettability with a substantial increase of the surface energy;

ii) a high processing yield with a reduced reject rate after surface activation, especially after activation via immersion in acidic solution;

iii) an improved paintability and paint adhesion performance after aging (80° C., 100% RH, 100-150 hours): and

iv) a retention of physical properties of the painted polyacetal articles even after weathering.

### BRIEF DESCRIPTION OF THE DRAWINGS

In the accompanying drawings:

FIGS. 1a and 1b are photographs showing typical surface artifacts and poor adhesion observed after painting two substrates of non-modified polyacetal.

FIGS. 2a and 2b are photographs respectively of a bad paint system and a paint system according to the invention with improved paintability and long term aging; and

FIG. 3 illustrates improvement of the mechanical performance of modified polyacetal resin over unmodified polyacetal resin at different stages of the pre-painting process.

### DETAILED DESCRIPTION

The invention provides painted polyacetal articles with good retained physico-mechanical properties and improved paint adhesion and high yield.

This invention relates to certain polyacetal compositions which after melt production (as by injection molding) are subject to adequate post treatment (flaming, sand blasting, Corona discharge, Plasma, UV . . . ). Preferably the post treatment is by etching from a mixed acid bath containing at least three acids from the group sulfuric acid, phosphoric acid, hydrochloric acid and an organic acid, and more preferably containing the four acids sulfuric acid, phosphoric acid, hydrochloric acid and acetic acid. The polyacetal compositions contain functional modifiers (described below) which retain the good properties of the polyacetal and which serve to enhance paint adhesion.

Among the different formulations of polyacetal resins that do show a good retention of the mechanical properties, low reject rate (high yield) as well as a good paintability, preferred resins contain a blend of first and second polyamide copolymers with different molecular weight (as described below). For example, the first polyamide has a molecular weight which is at least 5000 greater than that of the second polyamide, the first polyamide having a molecular weight in the range 20,000 to 50,000 and being present in an amount in the range 0.5-5 wt %, and the second polyamide has a molecular weight in the range 1,000 to 25,000 and is present in an amount equal to or less than the first polyamide and in the range 0.1-2.5 wt %. Preferably, the first polyamide is present in an amount 1-2 wt % and the second polyamide is present in an amount 0.25-1.5 wt %. More preferably, the resins contain one polyamide having a molecular weight of about 40,000 present at a level of about 1.5% and a second polyamide with a molecular weight of about 18,000 being present at level of about 0.5%.

The paint is applied to the polyacetal substrate from a solvent-borne, water-borne or powder paint system, as discussed below.

The required high performance (good adhesion, stiffness, toughness . . . ) is provided by the painted molded polyacetal resin product obtained by the resin composition, the surface treatment, and the applied thermoplastic or partly thermoplastic paint according to the present invention, as set out in greater detail below.

### Polyacetals

The term “Polyacetal” as used herein includes homopolymers of formaldehyde or of cyclic oligomers of formaldehyde, the terminal groups of which are end-capped by esterification or etherification, and co-polymers of formaldehyde or of cyclic oligomers of formaldehyde and other monomers that yield oxyalkylene groups with at least two adjacent carbon atoms in the main chain, the terminal groups of which copolymers can be hydroxyl terminated or can be end-capped by esterification or etherification.

The polyacetal used in the composition of the present invention can be branched or linear and will generally have a number average molecular weight in the range of 10,000 to 100,000, preferably 20,000 to 75,000. The molecular weight can be conveniently measured by gel permeation chromatography in m-cresol at 160° C. using a bimodal column kit with nominal pore size of 60 and 100 Å. Although polyacetals having higher or lower molecular weight averages can be used, depending on the physical and processing properties desired, the polyacetal molecular weight averages mentioned above are preferred to provide optimum balance of good mixing of the various ingredients to be melt blended into the composition with the most desired combination of physical properties in the molded articles made from such compositions.

As indicated above, the polyacetal can be either a homopolymer, a copolymer, or a mixture thereof. Copolymers can contain one or more comonomers, such as those generally used in preparing polyacetal compositions. Comonomers more commonly used include alkylene oxide of 2-12 carbon atoms and their cyclic addition product with formaldehyde. The quantity of comonomer will not be more than 20 weight percent, preferably not more than 15 weight percent, and most preferably about 2 weight percent. The most preferred comonomer is ethylene oxide. Generally polyacetal homopolymer is preferred over copolymer because of its greater stiffness and strength. Preferred polyacetal homopolymers include those whose terminal hydroxyl groups have been end-capped by a chemical reaction to form ester or ether groups, preferably acetate or methoxy groups, respectively.

Polyacetals are usually melt processed at a melt temperature of about 170° C.-260° C., preferably 185° C.-240° C. and most preferably 200° C.-230° C.

### Functional Modifiers

It has been found that polyacetals can be formulated in composition having improved paintability and good retained physico-mechanical properties. By retained properties we understand that the deterioration of physico-mechanical properties compared to unmodified and/or untreated molded polyacetal parts is negligible, for example when tested using an Impact pendulum of 0-40J (or not considerable max. Deviation of 10-15%). More specifically, when polyacetals are melt processed using certain meltable polymers (herein referred to as “functional modifiers” or “stabilizers” or “paint adherents”) at the processing Temperature, the resulting compositions are characterized by an improved resistance to oxidizing or non acid solutions, better paint adhesion and good physico-mechanical properties. These functional modifiers contain hydroxyl, carbonyl and/or amino groups, and they have a rather low molecular weight. These functional modifiers are unlike the non-meltable modifiers described in U.S. Pat. No. 5,011,890.

The functional modifier containing hydroxyl, carbonyl, methacrylate, amide, and/or amine groups and/or a combination thereof is meltable at the temperature at which the polyacetal is being processed. By the term “meltable” it is meant that the functional modifier or a combination of different functional modifiers have a major melting point below the temperature at which the polyacetal is melt processed and hence is liquid and preferably of low viscosity and undergoes significant melt flow at the processing temperature. Although it is almost impossible to quantitatively demonstrate a surface enrichment of the so-called “low melting point-low viscosity” functional modifiers it is presumed that the latter will migrate towards the surface during the process and hence provide the functionality or functionalities present at or just below the so-called skin microstructure of the processed polyacetal part. (as confirmed by ESCA measurement). Moreover, by adding these “low melting point-low viscosity” functional modifiers, prevention of cracking during acid etching with or without oxidizing solution has been put in evidence. It seems that when the above mentioned functional modifier(s) is (are) added to the formulation, the internal or residual stresses are partially relaxed providing the processed polyacetal parts with enhanced mechanical performance.

Polyamides (PA) are defined as being polymerized out of cyclic monomers (e-caprolactam for instance) and/or diamine/diacide for example hexamethylenediamine and adipic acid, including but not limited to nylons 6, 10, 11, 12, 46, 66, 69, 610, 612, 1212, and 6T. Polyamides include various copolymers, terpolymers, tetrapolymers and interpolymers made by condensing one or more dicarboxylic acids with one or more diamines; the condensation polymers of monoaminocarboxylic acids; and the polymers of lactams.

Functional modifiers (paint adherents) having an OH group are defined by polymers having vinyl alcohols and/or phenolic groups and/or other hydroxyl containing co-interpolymers (interpolymers meaning 2, 3, 4 or more monomeric units).

The functional modifier/paint adherant can be an acrylate or methylacrylate (MA) which may contain hydroxyl groups, amide, imide, carboxylic acid and or salts thereof and combination less reactive or less functional monomers such as sytrene, methyl methacrylate, methylacrylate, ethylacrylate, butylacrylate, glicidyl methacrylate, hydroxy ethyl methacrylate. The polymer stabilizer used in the compositions can be a homopolymer or copolymer containing formaldehyde-reactive nitrogen groups, formaldehyde reactive hydroxyl groups, or both formaldehyde reactive nitrogen and formaldehyde reactive hydroxyl groups. By “formaldehyde reactive” it is meant that the hydroxyl group contains an oxygen with a hydrogen atom bonded to it and the nitrogen group contains a nitrogen with one or two hydrogen atoms bonded to it. Formaldehyde will react with the —OH or the —NH bonds of the stabilizer polymer. These reactive sites are referred to herein as formaldehyde reactive sites. It is preferred that the polymer stabilizer contain formaldehyde reactive nitrogen or hydroxyl groups having the maximum number of formaldehyde reactive sites. For example, a polymer stabilizer containing formaldehyde reactive nitrogen groups wherein there are two hydrogen atoms attached directly to the nitrogen atom is preferred over one containing formaldehyde reactive nitrogen groups wherein there is only one hydrogen atom attached directly to the nitrogen atom.

### Thermoplastic Polymer Component

The at least one semicrystalline or amorphous non-acetal thermoplastic polymer may be selected from those thermoplastic polymers that are generally used by themselves, or in combination with others, in extrusion and injection molding processes. These polymers are known to those skilled in the art as extrusion and injection molding grade resins, as opposed to those resins that are known for use as minor components (i.e., processing aids, impact modifiers, stabilizers) in polymer compositions.

Generally substrates according to the present invention comprise about 0.5 to 10 weight percent of at least one non-acetal thermoplastic polymer, however, 1.5 to- 5 weight percent of the at least one non-acetal thermoplastic polymer is preferred. The polyoxymethylene/thermoplastic polymer blend substrate of the present invention contains a region, on or near the surface of the substrate, where the non-acetal polymer typically resides to promote adhesion. The thermoplastic polymer resides in this particular region because in a flowing mixture of immiscible fluids, the lowest viscosity liquid will tend to migrate to the region of highest shear. For example, in the case of injection molding, the wall of the mold cavity is the region of high shear, and thus, a higher concentration of the low viscosity polymer melt becomes concentrated somewhat on or near the surface of the part.

Semi-crystalline polyamides, polyesters and polyolefins can also be utilized in the present invention, either alone or in combination with one another, such that, each may be blended with the polyoxymethylene to promote adhesion.

For example, polyamides having relatively low melting points retain some level of crystallinity, but their low viscosity, high polarity and hydrogen bonding makes them useful for the purpose of the present invention. Polyolefins, preferably polar co- and ter-polymers such as ethylene-vinyl acetate copolymer (EVA) and ethylene butyl acrylate carbon monoxide terpolymer (EBACO), have proven useful to develop surface adhesion between a polyoxymethylene substrate and various surface treatments. Semi-crystalline polyesters also may generally comprise those with a melting point near or below that of polyacetal, such as, polycaprolactone. The non-acetal thermoplastic polymer can be incorporated into the composition as one thermoplastic polymer or as a blend of more than one thermoplastic polymer. Blends of the thermoplastic polymers may be used to adjust properties such as, for example, toughness or the compatibility of the major resin with the polyoxymethylene. Preferably, however, the substrate comprises one additional or alternative polymer such as an amorphous thermoplastic polymer or semi-crystalline polymer.

Whether it is incorporated as one thermoplastic polymer or as a blend of more than one, the weight percent of all non-acetal thermoplastic polymer(s) in the composition shall not exceed the weight percent ranges given above.

The term “thermoplastic” shall mean the polymer softens, when heated, to a flowable state in which under pressure it can be forced or transferred from a heated cavity into a cool mold and upon cooling in the mold, it hardens and takes the shape of the mold. Thermoplastic polymers are defined in this manner in the Handbook of Plastics and Elastomers (published by McGraw-Hill).

The term “amorphous” shall mean the polymer has no distinct crystalline melting point, nor does it have a measurable heat of fusion (although with very slow cooling from the melt, or with of sufficient annealing, some crystallinity may develop). The heat of fusion is conveniently determined on a differential scanning calorimeter (DSC). A suitable calorimeter is the DuPont Company's 990 thermal analyzer, Part Number 990000 with cell base 11, Part Number 990315 and DSC cell, Part Number 900600. With this instrument, heat of fusion can be measured at a heating rate of 20° C. per minute. The sample is alternately heated to a temperature above the anticipated melting point and cooled rapidly by cooling the sample jacket with liquid nitrogen. The heat of fusion is determined on any heating cycle after the first and should be a constant value within experimental error. Amorphous polymers are defined herein as having a heat of fusion, by this method, of less than 1 cal/g. For reference, semicrystalline 66 nylon polyamide with a molecular weight of about 17,000 has a heat of fusion of about 16 cal/g.

The thermoplastic polymers useful in the present compositions must be melt processible at the temperature at which the polyoxymethylene is melt processed. Polyoxymethylene is normally melt processed at melt-temperatures of about 170° C.-260° C., preferably 185° C.-240° C., and most preferably 200° C.-230° C.

The term “melt processible” shall mean that the thermoplastic polymer must soften or have a sufficient flow such that it can be melt compounded at the particular melt processing temperature for the polyoxymethylene.

The minimum molecular weight of the thermoplastic polymer (1000) is required in order to ensure compatibility, thermal stability and retain mechanical performance via chains entanglement, provided that the polymer has a degree of polymerization of at least ten and further provided that the polymer is melt processible (i.e., it flows under pressure) at the temperature at which the polyoxymethylene is melt processed. The maximum molecular weight of the thermoplastic polymer should not be so high that the thermoplastic polymer by itself would not be injection moldable by standard present techniques. The maximum molecular weight (50,000) for a polymer to be used for injection molding processes will vary with the individual particular thermoplastic polymer. However, the maximum molecular weight for use in injection molding processes is readily discernible by those skilled in the art.

Amorphous or semi-crystalline thermoplastic polyamides that are useful herein are well known in the art. They are described in U.S. Pat. No. 4,410,661. Specifically, these amorphous or semi-crystalline thermoplastic polyamides are obtained from at least one aromatic dicarboxylic acid containing 8-18 carbon atoms and at least one diamine selected from the class consisting of: (i) 2-12 carbon normal aliphatic straight-chain diamine, (ii) 4-18 carbon branched aliphatic diamine, and (iii) 8-20 carbon cycloaliphatic diamine containing at least one cycloaliphatic, preferably cyclohexyl, moiety, and wherein optionally, up to 50 weight percent of the polyamide may consist of units obtained from lactams or omega-aminoacids containing 4-12 carbon atoms, or from polymerization salts of aliphatic dicarboxylic acids containing 4-12 carbon atoms and aliphatic diamines containing 2-12 carbon atoms.

The term “aromatic dicarboxylic acid”, shall mean that the carboxy groups are attached directly to an aromatic ring, such as phenylene naphthalene, etc.

The term “aliphatic diamine”, shall mean that the amine groups are attached to a nonaromatic-containing chain such as alkylene.

The term “cycloaliphatic diamine”, shall mean that the amine groups are attached to a cycloaliphatic ring composed of 3-15 carbon atoms. The 6 or 12 carbon cycloaliphatic rings are preferred.

Preferred examples of thermoplastic polyamides include those with a melting point less than about 180° C., including co- and terpolymers of nylon 6, 610, 612 and the like.

Preferably, the semicrystalline or amorphous thermoplastic non-polyacetal resin comprises a blend of first and second polyamides of different molecular weights. In a preferred embodiment, the first polyamide has a molecular weight which is at least 5000 greater than that of the second polyamide, the first polyamide having a molecular weight in the range 20,000 to 50,000 and being present in an amount in the range 0.5-5 wt %, and the second polyamide having a molecular weight in the range 1,000 or 2,000 to 25,000 and being present in an amount equal to or less than the first polyamide and in the range 0.1-2.5 wt %.

The amorphous or semi-crystalline thermoplastic polyamides exhibit melt viscosities at 200° C. of less than 50,000 poise, preferably less than 20,000 poise measured at a shear stress of 105 dynes/cm². The amorphous or semi-crystalline polyamides are commercially available or can be prepared by known polymer condensation methods in the composition ratios mentioned above. In order to form high molecular weight polymers, the total moles of the diacids employed should approximately equal the total moles of the diamines employed.

In addition, free dicarboxylic acids, and derivatives thereof such as the chlorides, may be used to prepare the thermoplastic polyamide.

The polymerization to prepare the amorphous or semi-crystalline thermoplastic polyamides may be performed in accordance with known polymerization techniques, such as melt polymerization, solution polymerization and interfacial polymerization techniques, but it is preferred to conduct the polymerization in accordance with the melt polymerization procedure. This procedure produces polyamides having high molecular weights. In the polymerization, diamines and acids or cylic amides are mixed in such amounts that the ratio of the diamine components and the dicarboxylic acid components will be substantially equimolar. In melt polymerization, the components are heated at temperatures higher than the melting point of the resulting polyamide but lower than the degradation temperature thereof. The heating temperature is in the range of about 170° C. to 300° C. The pressure can be in the range of vacuum to 300 psi (approximately 2 MPa). The method of addition of starting monomers is not critical. For example, salts of combinations of the diamines and acids can be made and mixed. It is also possible to disperse a mixture of the diamines in water, add a prescribed amount of a mixture of acids to the dispersion at an elevated temperature to form a solution of a mixture of nylon salts, and subject the solution to the polymerization.

If desired, a monovalent amine or, preferably, an organic acid, may be added as viscosity adjuster to a mixture of starting salts or an aqueous solution thereof.

Amorphous thermoplastic polymers of acrylics, which are extrusion and injection molding grades, that are useful herein are well known in the art. Amorphous thermoplastic acrylic polymers comprise a broad array of polymers in which the major monomeric constituents belong to two families of ester-acrylates and methacrylates. Amorphous thermoplastic acrylic polymers are described on pages 103-108 in Engineering Plastics, referenced above. The molecular weight of the amorphous thermoplastic polymer of acrylics, for it to be injection moldable by standard present techniques, should not be greater than 200,000. Amorphous thermoplastic acrylic polymers are commercially available or can be readily prepared from known techniques by those skilled in the art. It is also known in the art that the substitution of a portion of the methyl methacrylate by styrene monomer can enhance the melt viscosity of poly methyl methacrylate, commercial examples may include from 20 to 60 weight % S.

Amorphous thermoplastic imidized acrylic resins that are useful herein are well known in the art. Amorphous thermoplastic imidized acrylic resins are prepared by reacting ammonia, or a primary amine, with an acrylic polymer, such as polymethyl methacrylate, to form the imidized acrylic resin (also known as polyglutarimides).

The imidized acrylic resin will contain at least about 10% imide groups and preferably at least about 40% imide groups, and can be prepared as described, for example, in U.S. Pat. No. 4,246,374 and in U.K. Patent 2,101,139B. Representative imide polymers include imidized poly(methyl methacrylate) or poly(methyl acrylate), imidized copolymers of either methyl methacrylate or methyl acrylate and comonomers such as butadiene, styrene, ethylene, methacrylic acid, or the like.

Amorphous thermoplastic imidized acrylic resins are also described in U.S. Pat. No. 4,874,817. Amorphous thermoplastic imidized acrylics are commercially available or can be readily prepared from known techniques by those skilled in the art.

### Further Components of the Polyacetal

The polyacetal resins are normally free of an inorganic filler but alternatively may contain a salt of a metal belonging to Group II of the Periodic Table facilitating by this way the formation of a roughened surface suitable for surface processing but reducing the physico-mechanical properties of the said compositions.

The composition of the present invention can include, in addition to the polyacetal and the stabilizer polymer, other ingredients, modifiers and additives as are generally used in polyacetal molding resins, including-co-stabilizers (such as those disclosed in U.S. Pat. Nos. 3,960,984: 4,098,843; 4,766,168 and 5,011,890), anti-oxidants, pigments, colorants, UV stabilizers, toughening agents, nucleating agents, and fillers.

### Surface Treatments

The surface of the polyacetal to be painted is treated by a surface modification technique selected from surface cleaning, etching, flaming, ionization, sanding, and UV exposure, or useful combinations of these treatments. The purpose of this treatment is to produce a rough surface and possibly form or reveal reactive groups on a part of the polyacetal molecule by the oxidizing action of the selected treatment.

A preferred treatment, in particular for complex shaped parts, is etching in a mixed acid bath containing at least three acids from the group sulfuric acid, phosphoric acid, hydrochloric acid and an organic acid, and in particular in a mixed acid bath containing sulfuric acid, phosphoric acid, hydrochloric acid and acetic acid.

Flaming is also a well-known and appropriate surface treatment for less complex shapes, for instance two-dimensional molded articles. A drawback versus immersion into acidic solution is that the shaped parts, once flamed, have to be painted right after surface activation in order to optimally promote good adhesion and avoid recombination of the activated reactive groups.

Sandblasting is also appropriate for less complex shapes; however it requires an additional cleaning step after surface roughening and generally results in less acceptable surface aesthetics. According to this technique, most of the adhesion is controlled by a mechanical anchorage of a decorative or functional layer. By decorative or functional layer, it is meant a paint coat, a metal coat or an additional coat, the function of which will be to provide an additional functionality such as a soft touch, an abrasive resistant layer or a low friction coat.

By ionization of the outermost surface layer is meant formation of ions as a result of a chemical reaction following a high temperature, electrical discharge or radiation. UV radiation can also be used to activate the surface and create some reactive groups to promote the wettability and adhesion of the paint system. By UV radiation is meant radiation having a wavelength in the range 250-400 nm.

By surface cleaning is meant wiping the surface using an alcohol for instance isopropanol (IPA). By doing this, traces of grease or mold release agent are definitively removed from the surface. Surface cleaning can be combined with other treatments.

If such surface treatments are applied to a polyacetal article that does not contain the requisite functional modifiers, problems arise such as deterioration of the polyacetal resin throughout the whole body, leading to loss of strength and the formation of cracks.

On the other hand, if the treatment is carried out utilizing a polyacetal having suitable functional modifiers, the surface modification can be achieved while preventing or reducing deterioration of the polyacetal article which maintains good physico-mechanical properties, and leading to improved adherence of the paint, even after long-term aging.

### The Paint System

The paint is applied to the treated polyacetal substrate from a solvent-borne, water-borne, 100% solid or powder coat 1K paint system onto the pretreated surface of the polyacetal substrate. The drying is done thermally or with a light source. The applied paint is a thermoplastic or partly thermoplastic paint. Thermoplastic (unlike thermoset) polymers do not branch three-dimensionally. They are meltable at their specific temperature of fusion and their mechanical performance is mainly controlled by their molecular weight. On the contrary, thermoset polymers do not have a temperature of fusion and hence do not melt but decompose at high temperature. Their physical performance is controlled by the 3-dimensional network formed during crosslinking and by the thermoset polymer's crosslinked density.

1K and 2K paint systems are well known to persons skilled in the art. By 1K paint system is understood that the paint system is composed by “one mixture of components” only, which is applied alone without mixing with a thermally-activated fast-operating crosslinking agent or promoter such that it is non-curable or substantially non-curable at low temperatures. On the other hand, in 2K paint systems, a mixable second component, which is a functional reactive component such as the crosslinker, is added in order to provide fast curing at low temperature, usually below 100° C. 2K paint systems are characterized by an inherently good chemical/solvent resistance making their use desirable. However, they do not perform well when applied as a base coat on polyacetal substrates, especially under severe aging conditions.

If the 1K paints are based on thermosetting binders, part or full crosslinking will also result in coating layers resistant to chemicals and solvents. However, unlike 2K paint systems, the crosslinking in this case is obtained at higher temperature in the range 140-180° C. The crosslinking could also be obtained with paint compositions where the binders react under the influence of UV, IR and NIR light. However, 1K paints based on thermosetting binders should only be used in the practice of the invention when the paints have a low curing rate.

If the 1K paints are based on thermoplastic binders, drying is only physical and less resistance to solvents and chemicals may be the result. However, the thermoplastic binders may also be crosslinked themselves in a particle dispersed form where the particles forming the dispersions are composed of crosslinked polymers as described in the open literature under non-aqueous dispersions (NAD's) and microgels, herein referred to as “partly thermoplastic”. The film formation process out of such particle dispersions is mostly accomplished through grafting or absorption of non-gelled polymers on the microgel cores. In paint systems such dispersions offer better resistance to solvents compared to high molecular weight binders typically used in paints based on thermoplastic binders.

Crosslinked particles also exist in the form of water dispersions or emulsions. Here the same principle as described above is used where there is an internal part crosslinked in the particle and the outside region at the periphery of the particle stabilizes the particle in the water phase and may also act as the film forming part. Crosslinking may also be achieved after film formation in the internal part of the particle across the boundaries through the reaction of functional groups. As non-limiting examples of partly thermoplastic binders, self-crosslinking dispersions contain epoxy, acid, alkoxymethylamide, methylolamide, hydroxy, amine acetoacetoxy, isocyanato, ketimine, aldimine, aziridine, oxazoline functional groups where self crosslinking emulsions based on methylol(meth)acrylamide are well known.

The initial coating should be thermoplastic or partly thermoplastic (non-crosslinked or partially crosslinked but non-fully thermoset) as per the above definition of non-aqueous dispersions (NAD's) and microgels. If the binder is a thermoplastic polymer, it should be characterized by a low glass transition temperature, preferably below 25° C. and most preferably below 0° C., and/or it should be modified with a plasticizer. By plasticizer is meant a chemical which reduces the stiffness of an amorphous (glassy) thermoplastic resin. Its main effect is to increase the molecular mobility of the polymer chains and consequently reduce the glass transition temperature of the amorphous resin. In the case of partly thermoplastic microgel dispersions, high molecular weight microgels are preferred, namely above 100,000.

Examples of binders used in the paints are alkyds, polyesters, acrylics, vinyl, cellulose acetate butyrate, nitrocellulose, epoxies, polyamides, polyamines and polyurethanes.

Examples of paint crosslinkers used in the partly themoplastic paints are melamine formaldehyde, urea formaldehyde, benzoguanamine formaldehyde based or polyisocyanates. If the paint systems are solvent borne, typical solvents include alcohols, ketones, ethers, acetates, aromatics, amide but are not limited to these.

As examples of the best 1K paint systems tested, providing improved paintability we have:

i) Centari® basecoat available from E.I. du Pont de Nemours and Company. This 1K basecoat comprises a thermoplastic binder system where the binder is based on a cellulose acetate butyrate, an oil-free polyester, a butylcarbamate plasticizer and a wax dispersion. The wax dispersion is a vinylacetate/ethylene copolymer. The tints in the Centari® basecoast are based on pigments and a special acrylic dispersion resin containing a tertiary amine modified. Basecoats comparable to Centari® systems but which have an acrylic instead of the oil free polyester have also shown good paintability (paint adhesion).

ii) Cromax® basecoat is a partly thermoplastic 1K paint system available from E.I. du Pont de Nemours and Company. This basecoat comprises an acid functional acrylic to disperse the pigments and as main binders a methylol methacrylamide based acrylic emulsion and chain extended polyester urethane emulsions. Similar basecoats based on an oligomeric phosphate as passivator, a polyurethane/acrylic hybrid dispersion and a polyester urethane emulsion not chain-extended have also demonstrated improved paintability.

In the present invention, a thermoplastic or partly thermoplastic base coat is applied to the modified polyacetal article in order to provide the best adhesion performance. The applied thermoplastic or partly thermoplastic paint is then advantageously covered with a layer of thermosetting paint or varnish. The concept developed here to maintain the adhesion performance while providing a maximum solvent or chemical resistance is based on a “sandwich concept” or two layers where the first layer, the 1K base coat, is a thermoplastic or partly thermoplastic, and the second layer, the 2K top coat, is a thermoset. The base coat gives the desired color and ensures by its intrinsic macromolecular nature the flexibility and “toughness” of the layer. This flexibility is required in order to balance the build up of stresses at the interface that may result from the crosslinking of the thermoset 2K clear coat. In the case of a thermoset 2K base coat, poor adhesion performance is usually observed after aging under saturated humidity, high temperature (80-90° C.) and long period (150 hours).

The thermoplastic or partly thermoplastic 1K paint, and also the 2K topcoat, can be applied by dipping, spraying, brushing or powder application.

As mentioned above, the applied paint can be a decorative or functional layer. The paint can include functional additives for instance to provide a soft touch, an abrasive resistant layer or a low friction coat, or a reinforcement.

### Preparation of a Mixed Acid Etching Bath

A mixed acid etching bath of the following composition, given by way of example, was prepared for the comparative testing reported below: sulfuric acid 34.5 weight %; phosphoric acid 29.0 weight %; hydrochloric acid 4.5 weight %; acetic acid 8.5 weight % and water 23.5 weight %. In this example the weight ratio of sulfuric to phosphoric acid is 1.18 and the weight ratio of hydrochloric to acetic acid is 0.52.

### Etching of Polyacetal Articles for Painting

The molded modified polyacetal articles to be painted are cleaned by dipping them in a cleaner bath with a surfactant at weak alkaline pH (like PM 900 available from Shipley SAS of Paris, France), at a temperature up to 50° C. for 2 to 3 minutes, then rinsing them with water prior to etching. Alternatively, the articles are annealed, cooled, cleaned and rinsed.

Etching in the above-described mixed acid bath is conveniently performed at 25 to 35° C. for 10 to 30 minutes. Colder conditions require a longer treatment. The solution can be stirred to uniformize etching of the modified polyacetal surface. During etching, fumes are exhausted for safety and air control.

Etching is followed by rinsing under water, neutralization, cold rinsing and hot rinsing. The etched parts to be painted are then dried, loaded onto supports in a painting line, painted with an organic paint and a top coat if necessary, cured and then unloaded and controlled.

### Comparative Tests

Parts, namely ski bindings were injection molded using commercial non-modified or modified acetal resins, as specified below. All parts were subjected to the above-described surface treatment in a mixed acid etching bath. 1K and/or 2K paint systems were applied as detailed. The modified resins contained two polyamides, one having a molecular weight of 40'000 present at a level of 1.5% and a second with a molecular weight of about 18'000 present at level of 0.5%. The paint adhesion performance was measured according to the ISO 2409 standard (cross-cut test).

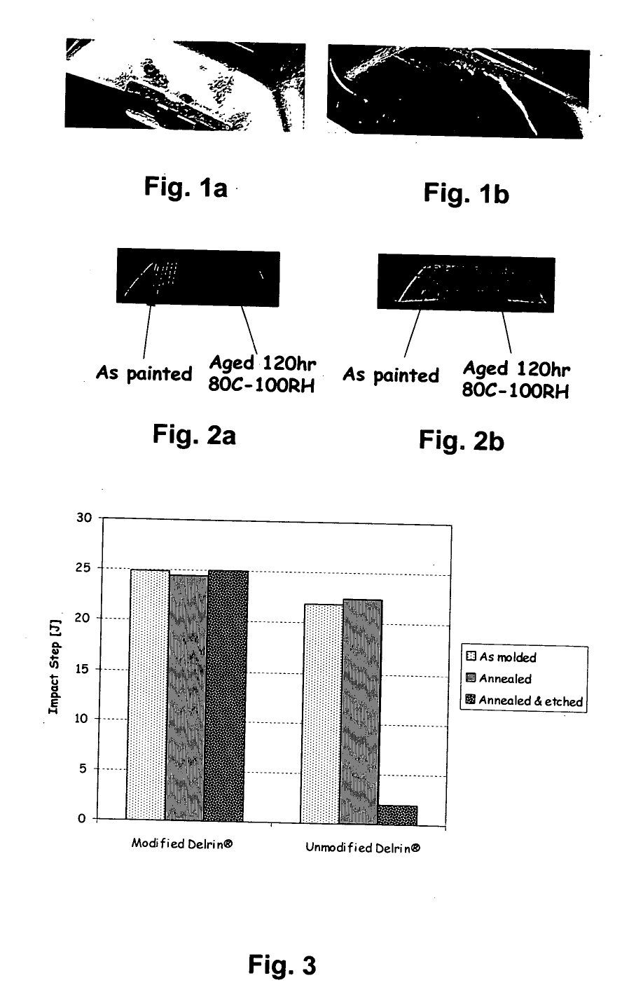

FIGS. 1a and 1b show photographs of the surface of painted molded parts, namely ski bindings, molded by injection using two different non-modified commercial Delrin® 100 and 100T acetal grades. The base coat paint system used is a waterborne Cromax®1K paint system and the top-coat a 2K acrylic clear coat. In FIG. 1a, dots are observed which is unacceptable from a surface aesthetic point of view. These dots were probably generated by a mismatch in surface energetics controlled by the local macromolecular structure. The photograph of FIG. 1b is spotless but characterized by a poor adhesion when measured according to ISO 2409. Basically, these photographs summarize the main artifacts in terms of either bad surface aesthetics or poor adhesion performance encountered when painting non-modified acetal resins.

FIGS. 2a and 2b show photographs of painted molded parts, namely ski bindings, molded by injection using modified Delrin® 100 acetal grades. In FIG. 2a, both the base coat and the top coat system are 2K thermosets. As shown in the left part of FIG. 2a, the adhesion performance is good immediately after painting, but a loss of adhesion is observed after aging for 120 hours at 80° C. in a humidity saturated atmosphere (100% RH), as shown on the right of FIG. 2a.

FIG. 2b shows a sample according to a preferred embodiment of the invention, namely the new concept of the application of a thermoplastic 1K base coat and a 2K thermoset top coat. By comparison with FIG. 2a, this photograph clearly demonstrates the improvement in adhesion performance obtained according to the invention, before and after aging, as shown respectively on the left and the right of FIG. 2b.

FIG. 3 graphically compares the impact performance, measured in impact steps and expressed in Joules, of commercial non-modified Delrin® 107 NC and modified Delrin® to be painted. The tests were performed using an impact pendulum of 0-40J and the recorded values were measured i) shortly after the article was molded, ii) after annealing at 150° C. for 30 min and iii) after annealing and etching. From the results, it can be seen that the unmodified acetal (commercial Delrin® 107 NC) suffers from the etching; namely the molded article drastically lost its impact performance after etching. On the other hand, the modified molded article of the invention did maintain the high impact performance characteristic of the acetal resins even after etching, which provides good mechanical properties and a high yield. The yield is defined here as the percentage of molded parts that are not characterized by a reduction in impact strength greater than 25-30% after surface activation.

These results clearly show that the beneficial effects of the invention are obtained only for the modified polyacetals subjected to the surface treatment and with the selected 1K thermoplastic paint system applied directly to the treated surface. Non-modified polyacetals even if coated with the 1 K thermoplastic paint system do not perform well (FIGS. 1a and 1b). Likewise, modified polyacetals coated directly with a 2K thermoset paint do not perform well (FIG. 2a). FIG. 2b demonstrates the good performance of the inventive painted acetals even after severe aging. FIG. 3 establishes that modification of the polyacetals is necessary to maintain physical characteristics after surface treatment.

1. A painted polyacetal article comprising:
a polyacetal substrate comprising 90-99.5 wt % polyacetal and 0.5-10 wt % of semicrystalline or amorphous thermoplastic non-polyacetal resin of molecular weight 1,000-50,000; and
a paint applied to the polyacetal substrate from a solvent-borne, water-borne or powder 1K paint system onto a surface of the polyacetal substrate pretreated to enhance exposure of said semicrystalline or amorphous thermoplastic non-polyacetal resin of the substrate to the applied paint;
said paint being a thermoplastic or partly thermoplastic paint.

2. The painted polyacetal article of claim 1, wherein the substrate comprises 95-98.5 wt % polyacetal and 1.5-5 wt % of the semicrystalline or amorphous thermoplastic non-polyacetal resin.

3. The painted polyacetal article of claim 1, wherein the semicrystalline or amorphous thermoplastic non-polyacetal resin has a nitrogen group, an OH group, or an acrylate, or methacrylate functionality.

4. The painted polyacetal article of claim 3, wherein the semicrystalline or amorphous thermoplastic non-polyacetal resin comprises at least one amide.

5. The painted polyacetal article of claim 4, wherein the semicrystalline or amorphous thermoplastic non-polyacetal resin comprises a blend of first and second polyamides of different molecular weights.

6. The painted polyacetal article of claim 5, wherein the first polyamide has a molecular weight which is at least 5000 greater than that of the second polyamide, the first polyamide having a molecular weight in the range 20,000 to 50,000 and being present in an amount in the range 0.5-5 wt %, and the second polyamide having a molecular weight in the range 1,000 to 25,000 and being present in an amount equal to or less than the first polyamide and in the range 0.1-2.5 wt %.

7. The painted polyacetal article of claim 6, wherein the first polyamide is present in an amount 1-2 wt % and the second polyamide is present in an amount 0.25-1.5 wt %.

8. The painted polyacetal article of claim 1, wherein the paint system contains a thermoplastic polymer with a glass transition temperature below 25° C.

9. The painted polyacetal article of claim 1, wherein the applied thermoplastic or partly thermoplastic paint is covered with a layer of thermoset paint or varnish.

10. A process of producing a painted polyacetal article, comprising:
providing a polyacetal substrate produced by solidifying a molten blend comprising 90-99.5 wt % polyacetal and 0.5-10 wt % of semicrystalline or amorphous thermoplastic non-polyacetal resin of molecular weight 1,000-50,000;
treating a surface of the polyacetal substrate for the application to the treated surface of a paint, to enhance exposure of said semicrystalline or amorphous thermoplastic non-polyacetal resin to an applied paint; and
applying a thermoplastic or partly thermoplastic paint from a solvent-borne, water-borne or powder 1K paint system onto the treated surface of the polyacetal substrate.

11. The process of claim 10, wherein the surface of the polyacetal substrate is treated by a surface modification technique selected from etching, flaming, ionization, sanding, surface cleaning and UV exposure.

12. The process of claim 11, wherein the surface of the polyacetal substrate is treated by etching from a mixed acid bath containing at least three acids from the group sulfuric acid, phosphoric acid, hydrochloric acid and an organic acid.

13. The process of claim 12, wherein the mixed acid bath contains sulfuric acid, phosphoric acid, hydrochloric acid and acetic acid.

14. The process of claim 10, wherein the polyacetal substrate is provided by molding, extrusion or thermoforming.

15. The process of claim 10, wherein the thermoplastic or partly thermoplastic paint is applied by dipping, spraying, brushing or powder application.

16. The process of claim 10, which comprises covering the applied thermoplastic or partly thermoplastic paint with a layer of thermosetting paint or varnish.

17. The process of claim 10, wherein the semicrystalline or amorphous thermoplastic non-polyacetal resin comprises a blend of first and second polyamides of different molecular weights, wherein the first polyamide has a molecular weight which is at least 5000 greater than that of the second polyamide, and the first polyamide has a molecular weight in the range 20,000 to 50,000 and is present in an amount in the range 0.5-5 wt %, and the second polyamide has a molecular weight in the range 1,000 to 25,000 and is present in an amount equal to or less than the first polyamide and in the range 0.1-2.5 wt %.
